(19) United States
(12) Patent Application Publication
(10) Pub. No.: US 2019/0045992 A1
(43) Pub. Date: Feb. 14, 2019

(54) METHOD FOR OPERATING AN AUTONOMOUSLY TRAVELING FLOOR TREATMENT DEVICE

(71) Applicant: Vorwerk & Co. Interholding GmbH, Wuppertal (DE)

(72) Inventors: Maike BREDE, Witten (DE); Pia HAHN, Schwelm (DE); Lorenz HILLEN, Wuppertal (DE); Gerhard ISENBERG, Koeln (DE); Harald WINDORFER, Mettmann (DE)

(73) Assignee: Vorwerk & Co. Interholding GmbH, Wuppertal (DE)

(21) Appl. No.: 16/058,052

(22) Filed: Aug. 8, 2018

(30) Foreign Application Priority Data
Aug. 11, 2017 (DE) 10 2017 118 381.7

(51) Int. Cl. A47L 9/28; A47L 11/24; A47L 11/40; G05D 1/02

(52) U.S. Cl. CPC A47L 9/2826; A47L 11/24; A47L 9/2857; A47L 11/4011; G05D 2201/0203; G05D 1/0212; A47L 2201/04; G05D 2201/0215; A47L 11/4061

(57) ABSTRACT

A method for operating a floor treatment device that travels autonomously within an environment, wherein the floor treatment device performs a treatment of a defined and spatially limited partial surface region of the environment. During the treatment of the partial surface region a detection device of the floor treatment device measures a treatment status of the partial surface region, compares the treatment status is with a defined reference status and continues a treatment of the partial surface region until the defined reference status is reached. In order to improve the result of a floor treatment operation, a user defines the reference status manually and transmits it to the floor treatment device.

### CROSS REFERENCE TO RELATED APPLICATIONS

Applicant claims priority under 35 U.S.C. § 119 of German Application No. 10 2017 118 381.7 filed Aug. 11, 2017, the disclosure of which is incorporated by reference.

### BACKGROUND OF THE INVENTION

### 1. Field of the Invention

The invention relates to a method for operating a floor treatment device that travels autonomously within an environment, wherein the floor treatment device performs a treatment of a defined and spatially limited partial surface region of the environment, wherein during the treatment of the partial surface region a detection device of the floor treatment device measures a treatment status of the partial surface region, wherein the treatment status is compared with a defined reference status and a treatment of the partial surface region is continued until the defined reference status is reached.

The invention further relates to a floor treatment device which moves autonomously within an environment, which is designed to perform a cleaning of a defined spatially delimited partial surface region of the environment.

### 2. Description of the Related Art

Floor treatment devices of the above-named type and methods for their operation are known in the prior art.

The floor treatment device may be, for example, a cleaning robot, which can automatically perform a vacuum cleaning task and/or a mopping task. Furthermore, the floor treatment device can also be a polishing device, a sanding device, a lawn-mowing robot or similar.

The publications DE 10 2011 000 536 A1 and DE 10 2008 014 912 A1 disclose, for example, methods in connection with autonomously movable vacuuming and/or cleaning robots for cleaning floors. The robots are equipped with distance sensors, which measure distances to obstacles, such as pieces of furniture or room boundaries. From the measured distance data, a map of the environment is created, on the basis of which a travel route can be planned that avoids a collision with obstacles. The distance sensors preferably operate in a contactless manner, for example by means of light and/or ultrasound. It is also known to equip the robot with means for all-round distance measurement, for example, with an optical triangulation system, which is arranged on a platform or the like that rotates about a vertical axis. The recorded distance data are processed using a processing device of the robot to produce a map of the environment and then stored, so that in the course of a working operation this environment map can be accessed for the purpose of orientation.

Furthermore the prior art, for example in EP 1 967 116 B2, also discloses a treatment of a floor area depending on a contamination level of individual regions of the floor area. In particular, the individual areas can be approached by the cleaning robot and processed in different ways depending on the level of contamination.

In addition, EP 1 711 873 B1 discloses a cleaning robot which is operated in a spot-cleaning mode, if a dirty area is detected. The spot-cleaning mode is implemented for a predetermined or random period of time, for a specific or random distance and/or until a specific event occurs.

A disadvantage of the above-mentioned methods is that they perform the cleaning activity of the cleaning appliance regardless of a cleaning outcome, so that some contamination with dirt may still be present, at least in part, after the end of the cleaning operation.

### SUMMARY OF THE INVENTION

On the basis of the above-mentioned prior art the object of the invention is therefore to create a method for operating a floor treatment device traveling autonomously within an environment, in which the treatment outcome, i.e. for example a cleaning quality, is further improved.

To achieve this object, it is proposed that a user defines the reference state manually and transmits it to the floor treatment device.

The reference state is defined by a user manually and transmitted to the floor treatment device. In particular, the reference state can be defined using an application installed on an external terminal device. The external terminal can preferably be a mobile terminal, such as a mobile telephone, a laptop, a tablet computer, or similar. The nature of the surface region can be a type of flooring, for example a carpeted floor or hard floor. The type of contamination can be, for example, coarse material, fine particles, hairs, dirty liquid, sticky dirt or similar. In addition, the reference state can also be defined for a specific location and/or size of the partial surface region. In addition, the control device of the floor treatment device or else a user can define a geometric shape or size for a partial surface region. The geometric shape can be, for example, a square, rectangle, polygon, triangle, circle or similar. In addition, a size of the partial surface region to be treated can be defined. This size can either specify an area size or a radius relative to a centre of an area, or the like. Depending on the nature of the partial surface region, the nature of the dirt contamination and/or the location or size of the partial surface region, for example a desired cleaning outcome, i.e. treatment status, can then be defined for a cleaning appliance, a mowing outcome for a lawn mower or similar. Different reference states can be defined for different types of surface regions, for example floor types, so that threshold values for carpeted floors, for example, are higher than for hard floors, since it can be assumed that in the case of a carpeted floor, fibres of the carpet are detected by a detection device of the cleaning appliance as dirt, although they are not dirt but in fact an intrinsic part of the carpet.

A current treatment status of the surface to be treated is relevant to the termination of a treatment operation of the floor treatment device. The treatment of the surface is continued until the current treatment status matches the defined reference status. The reference status therefore specifies a termination criterion for the operation of the floor treatment device. The reference status may include a plurality of conditions, which when satisfied trigger the termination of the treatment of the partial surface region.

The method can be used to operate different floor treatment devices, such as cleaning appliances, sanding tools, polishing machines, lawnmower robots et cetera. The treatment status is defined depending on the type of the floor treatment device and in the case of a cleaning appliance can be, for example, a cleanliness condition of the partial surface region, in the case of a lawnmower robot a mowed condition of a lawn area, etc.

In the method according to the invention the duration of the treatment operation is not defined in advance, but varies according to the treatment status, for example, the duration of a cleaning operation is continued depending on a state of cleanliness of the relevant partial surface region. The cleaning appliance cleans the partial surface region until such time as the target cleanliness condition is reached, or an even until a better cleaning quality is achieved than that defined by the target cleanliness condition. With increasing treatment duration, the treatment intensity that the floor treatment device exercises on the partial surface region also increases. During operation, a current treatment status is detected continuously, regularly or else irregularly by means of the detection device of the floor treatment device. The detection device can be, for example, a camera that takes pictures of the partial surface region, or a dirt sensor which measures a presence of dust and/or dirt within a suction air stream that is drawn in by a motor/blower assembly of the cleaning appliance. For example, an area-related quantity of dust can be evaluated, which provides an indication of a level of contamination.

According to an embodiment of the invention it is proposed that the treatment status is a contamination level of the partial surface region, wherein the contamination level is compared with a defined reference contamination level and wherein a process of cleaning the partial surface region is continued until the level of contamination is below the defined reference contamination level. This embodiment relates to a floor treatment device implemented as a cleaning appliance, in which a contamination status, for example a quantity of dirt per unit area, is applied for the comparison with a defined reference. In addition, a type and/or consistency of a contamination may also be compared. It is also possible to classify the current level of contamination into different categories, in particular to compare it with a plurality of defined reference contamination levels which characterize a contamination as for example, low, medium or high. Depending on this, a different or additional surface cleaning measure can then be executed as appropriate, for example an operation of an additional cleaning element, the application of a cleaning agent, or similar.

It is also proposed that in the defined spatially delimited partial surface region a spot-cleaning mode with increased cleaning performance compared to a standard mode is implemented. The spot-cleaning mode can be limited to a partial region of, for example, a few square metres, for example a square region of 2 m by 2 m. In this partial surface region, the floor treatment device moves, for example, along a plurality of lines oriented parallel to each other. In doing so the floor treatment device can run through a plurality of cleaning cycles in succession, wherein the floor treatment device returns to a defined starting point after each cleaning cycle and from there runs through the specified route again. The repeated traversal of each individual location of the partial surface region allows an increased cleaning performance to be achieved. Furthermore, in the spot cleaning mode other cleaning measures, such as a brushing of the surface to be cleaned, or other measures can also be provided.

It is provided that the reference status comprises a target specification for a treatment quality of the partial surface region. This target treatment state can have pre-defined categories for the treatment quality of the partial surface region. In the case in which the treatment quality is a cleaning quality, the reference status can, for example, be defined relative to a desired level of contamination of the partial surface region or specify an absolute amount of contamination per unit area. In the case that the target cleaning state is defined as a function of the original contamination level, an actual level of contamination can first be determined during a learning excursion, or else on a first cleaning cycle. This level of contamination is then defined as the reference. The target cleaning state can then be selected from a predefined selection menu that comprises a plurality of levels, for example, an optimal state of 0 per cent of the original contamination level, a normal cleanliness state of 10 per cent of the usual contamination level, or a quick cleaning condition, with a value of 25 per cent of the original level of contamination. In the case of an absolute definition of the target cleaning state, for example, a quantity of dirt can be used as a benchmark. In the cleaning appliance, threshold values are then stored for different cleanliness states that are defined for a specified standard surface area. A cleanliness state is defined as optimal if no dirt particles are detected per standard surface area.

It is also proposed that the reference status is defined as a function of a type of the partial surface region and/or a type of contamination and/or a location and/or size of the partial surface region.

It is also proposed that the treatment of the partial surface region comprises a plurality of temporally consecutive treatment cycles, wherein the comparison is performed during or after a treatment cycle. This embodiment is particularly suitable in the case of a spot-cleaning of the partial surface region, which contains a plurality of consecutive treatment cycles. After each treatment cycle the cleaning appliance can compare the current treatment status, in particular cleaning outcome, with one or more defined cleaning states. If at the end of the treatment cycle the detected treatment status, e.g. the level of contamination, is not less than before or is even worse than the desired reference status, a further treatment cycle is started, which is preferably executed on the same trajectory as the previous treatment cycles. To prevent the cleaning appliance from executing an infinite loop of successive treatment cycles because a detected contamination cannot be removed, it is advisable to define a termination criterion. This allows an exit condition to be specified, and in particular a current dirt collection capacity of the cleaning appliance can be determined and compared with a limit value. If this limit value is undershot, the exit condition is satisfied and no new treatment cycle is started. The information that a contamination is still present on the surface, but the cleaning appliance cannot eliminate it, can be displayed to a user on an external terminal, for example in a smartphone app, as a text message, or similar. The user can then apply, for example, a different cleaning appliance with an alternative cleaning method, perform a manual cleaning themselves, or similar.

In particular, it is proposed that the comparison is performed while the floor treatment device is stationary at a defined start/stop position. In accordance with this embodiment, the floor treatment device returns to the start-stop position after each treatment cycle, where the treatment status detected in the last treatment cycle is then compared with the defined reference status. If it is detected that the desired reference status has not yet been reached, the floor treatment device is restarted from the start/stop position and moved over the partial surface region again. On reaching the defined reference status or on satisfaction of an exit condition, the floor treatment device can assume a parked position, which is a position at a base station of the floor treatment device, for example.

Finally, it is proposed that during the treatment of the partial surface region the floor treatment device moves along a meandering trajectory, or along trajectories oriented parallel to each other. The partial surface region is therefore treated along a defined regular trajectory, which includes parallel directions of travel. One such mode, for example, is a spot-cleaning mode of a cleaning appliance.

In addition to the previously described method for operating a floor treatment device which moves autonomously within an environment, the invention also proposes a floor treatment device which moves autonomously within an environment, which is designed to perform a cleaning of a defined spatially delimited partial surface region of the environment, wherein the floor treatment device comprises a control device which is configured to control the floor treatment device for executing a method as previously described. The advantages and further features of the floor treatment equipment according to the invention are obtained as previously described in reference to the method according to the invention. The floor treatment device, as previously discussed, can also be a cleaning appliance, a polishing device, a sanding device, a lawn-mowing robot or other device, which performs a floor treatment task and in order to do so, compares an actual treatment status of a partial surface region with a desired reference status.

### BRIEF DESCRIPTION OF THE DRAWINGS

In the following the invention is explained in further detail based on exemplary embodiments. Shown are:

FIG. 1 a perspective view of a floor treatment device,

FIG. 2 an external terminal with an environment map of the floor treatment device,

FIG. 3 an external terminal with an environment image of the environment of the floor treatment device,

FIG. 4 a selection menu for selecting parameters for a floor treatment operation,

FIG. 5 an environment with a partial surface region, in which the floor treatment device is to proceed,

FIG. 6 an environment with a partial surface region, in which a user places the floor treatment device.

### DETAILED DESCRIPTION OF THE PREFERRED EMBODIMENTS

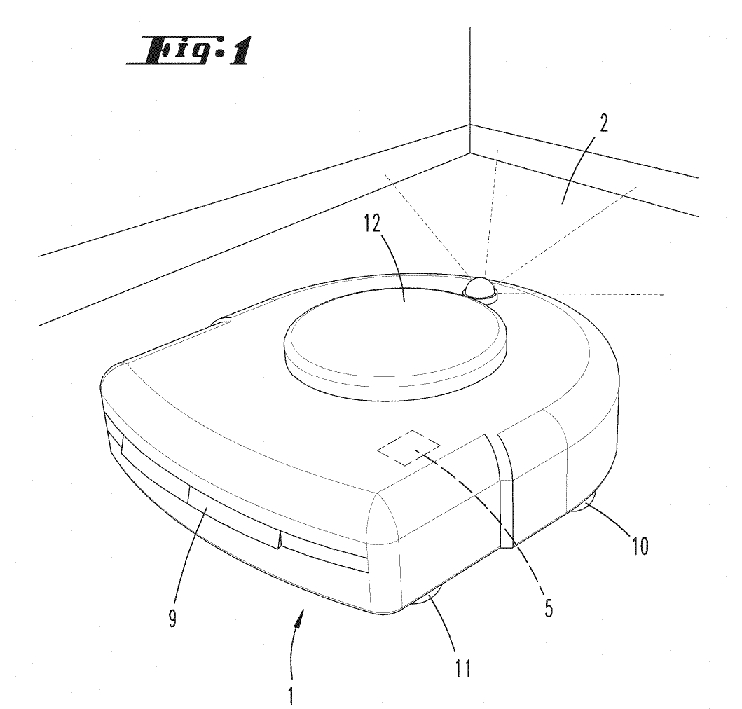

FIG. 1 shows a floor treatment device 1 which is designed here as a vacuum-cleaner robot. The floor treatment device 1 has electric-motor driven wheels 10, which the floor treatment device 1 uses to enable it to move within an environment. Furthermore, the floor treatment device 1 has cleaning elements 11, namely here, among others, a roller brush, which in the normal operating position shown of the floor treatment device 1 is oriented substantially horizontally, i.e. substantially parallel to a partial surface region 2 to be cleaned. In the area of the cleaning element 11 the floor treatment device 1 has a suction opening, not shown in detail, through which air loaded with suction material can be drawn into the floor treatment device 1 by means of a motor and blower assembly. For the energy supply of the individual electrical components, such as for a drive motor of the wheels 10, the cleaning element 11 and additionally provided electronics, the floor treatment device 1 has a rechargeable battery, not shown.

The floor treatment device 1 also has a distance measuring device 12, which here includes, for example, a triangulation measuring device. The distance measuring device 12 is arranged within the housing of the floor treatment device 1 and specifically comprises a laser diode, the emitted light beam of which is guided out of the housing via a deflection device and can be rotated about a vertical axis of rotation in the illustrated orientation of the floor treatment device 1, in particular with a measuring angle of 360°. As a result, an all-round distance measurement around the floor treatment device 1 is possible. The distance measurement device 12 measures distances to obstacles, for example, pieces of furniture, within the environment of the floor treatment device 1.

The floor treatment device 1 also has a detection device 9, namely here an image sensor arranged facing forwards in the direction of travel of the floor treatment device 1, which sensor can detect a contamination of the partial surface region 2 currently being traversed by the floor treatment device 1. The detection device 9 records images of the partial surface region 2 and compares these with images of a reference contamination. Alternatively, the detection device 9 could also be a dust sensor, which is arranged in a flow supply to the motor and blower assembly of the floor treatment device 1 and detects dirt particles. The floor treatment device 1 has a control device 5, which is designed to perform the comparison between a contamination level recorded by the detection device 9 and one or more reference contamination levels stored in the floor treatment device 1. For this purpose, the control device 5 can alternatively also access an external storage unit with which the floor treatment device 1 is in communication.

If the floor treatment device 1 is a different device than the exemplary cleaning appliance shown here, then the detection device 9 could be designed to measure another parameter of the partial surface region 2. In a lawnmower robot this could be, for example, a mown or not yet mown condition of a region of the lawn area.

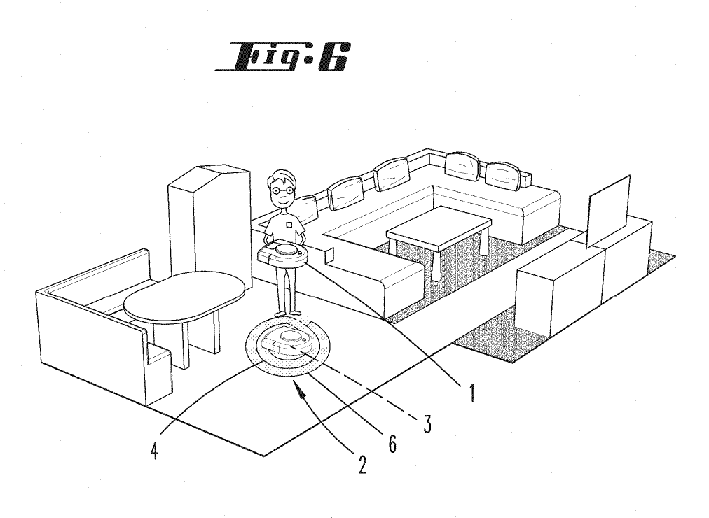

The floor treatment device 1 follows a trajectory 4 (see FIGS. 5 and 6) within the environment to clean one or more partial surface regions 2. This trajectory 4 can be, for example, a route of travel of the floor treatment device 1 during a spot-cleaning mode in which the floor treatment device 1 cleans a limited partial surface region 2 with increased cleaning performance of the motor and blower assembly compared to a standard mode. In this spot-cleaning mode, the floor treatment device 1 traverses the partial surface region 2, starting for example from a start-stop position 3, along a helical trajectory 4 and removes dirt there.

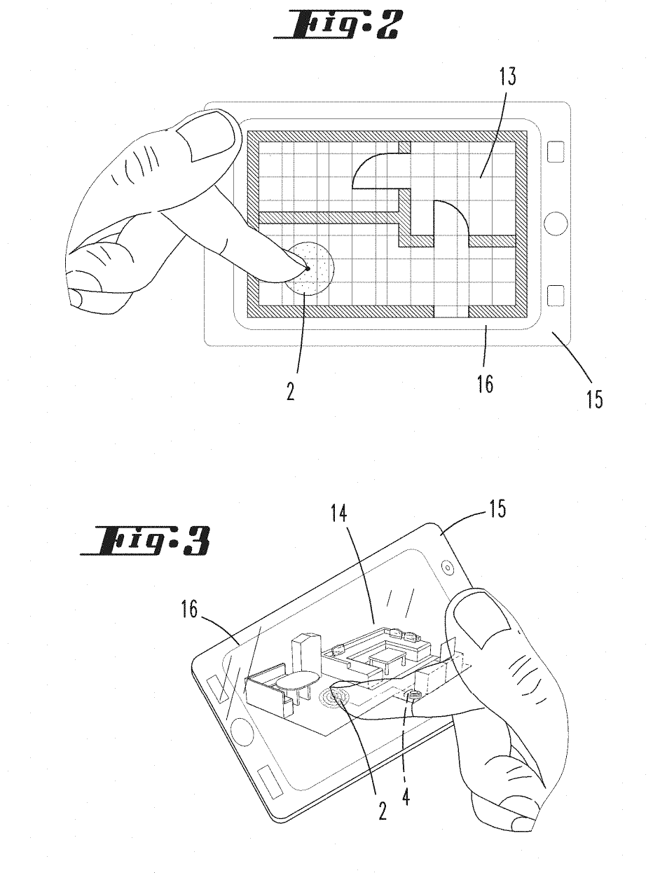

FIGS. 2 and 3 show a user input by a user on an external terminal 15 which is in communication with the floor treatment device 1. The external terminal 15 in FIG. 2 is, for example, a tablet computer, on the display 16 of which an environment map 13 of the floor treatment device 1 is displayed. According to FIG. 3 the external terminal 15 is a mobile telephone, on the display 16 of which an environment image 14 of the environment of the floor treatment device 1 is shown. The environment image 14 is, for example, a camera recording from the detection device 9. As shown in FIGS. 2 and 3, in the environment map 13 or the environment image 14 the user can select a partial surface region 2 of the environment, for example a specific sub-region of a flat or a room, in which a floor treatment, here a cleaning process, is to take place. By tapping on an area on the display 16 of the external terminal 15, a partial surface region 2 can be highlighted.

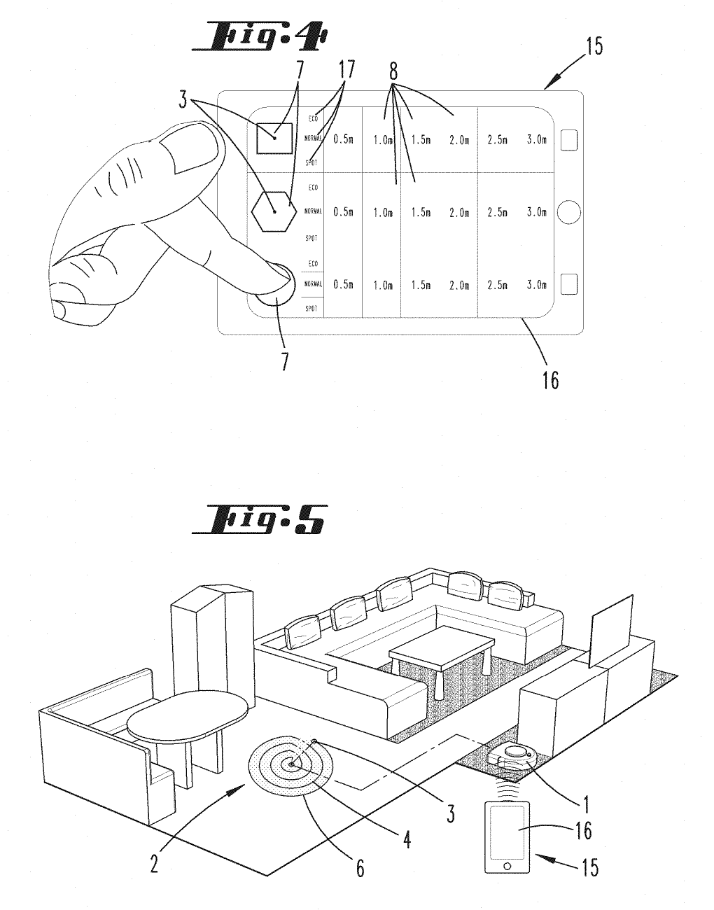

In addition, as shown in FIG. 4, the user has the facility to define parameters for the treatment of the partial surface region 2. For this purpose, as shown in FIG. 4, a selection menu can be displayed to the user on the display 16 of the external terminal 15, which indicates various area shapes 7 and area sizes 8 for the partial surface region 2 on which a spot-cleaning is to be carried out. The area size 8 indicated here designates, for example, a half side-length of the respective surface shape 7 starting from a central start/stop position 3. In the top row of the table shown, the area size 8 of “0.5 m” therefore means a square area shape 7 with a total area of (2×0.5 m)², i.e. 1 m². A selectable area size 8 of “1.0 m” means a partial surface region 2 to be covered by the floor treatment device 1 with a total surface area of 4 m². In the circular shape shown in the bottom row of the table, the area size 8 designates the radius of the circle on the partial surface area 2 to be cleaned. Furthermore, the user can select a treatment mode 17 in the table shown, for example, an eco-mode, a normal mode or a performance-increased spot-cleaning mode.

FIG. 5 shows an environment with a floor treatment device 1, which a user can control using an external terminal 15. The user can send a command to the floor treatment device 1 to move to a selected partial surface region 2 with a start-stop position 3. The start-stop position 3 is located on the outer circumferential path 6 of the circular partial surface region 2.

By contrast, FIG. 6 shows an embodiment in which the user him/herself places the floor treatment device 1 on a desired partial surface region 2 themselves, namely centrally on a start-stop-position 3, which is a centre of the desired circular shaped area 7. During the spot-cleaning mode selected here the floor treatment device 1 proceeds along a spiral trajectory 4 and returns to the start-stop position 3 after each traversal of the trajectory 4. The manual placement is performed such that the floor treatment device 1 is placed by the user centrally in the partial surface region 2 to be cleaned. This position is used as a start-stop position 3 for each of a plurality of successive cleaning cycles. Using an external terminal 15 or else a keyboard or touch screen of the floor treatment device 1, the user selects the area size 8 that is to be cleaned.

In the virtual placement of the floor treatment device 1 according to FIG. 5, the user indicates the desired position of the floor treatment device 1 in an environment map 13 or environment image 14 displayed on the display 16 of the external terminal 5. Thereafter the floor treatment device 1 moves to the selected start-stop position 3 associated with the partial surface region 2.

In addition, the user can select a desired target treatment status, which here, for example, indicates a specified level of contamination for the partial surface region 2 to be cleaned. Furthermore, a time-delayed cleaning or cleaning at a specific time can also be selected by means of the external terminal 15. Furthermore, it is also possible to define regular intervals for a cleaning run of the floor treatment device 1.

To define the target treatment status, the user can make a selection from a plurality of possible predefined treatment states, which relate either to a defined final contamination level or to an absolute level of contamination per unit area. In the case that, for example, a contamination level is defined relative to an initial contamination level, the original contamination level is initially detected during a first cleaning cycle, i.e. an initial excursion of the floor treatment device 1. The target treatment status can be selected from a predefined selection list which comprises, for example, the following steps: “Optimal” is equal to a reduction of the level of contamination to 0 per cent of the original contamination level, “Normal” is equal to reduction of the level of contamination to 10 per cent of the original contamination level, “Fast” is equal to reduction of the level of contamination to 25 per cent of the original level of contamination. If the target treatment status is defined by a surface-based sensor signal, for example a number of dirt particles per standardized unit of area can be defined. In the floor treatment device 1 defined reference states are stored that are defined for a standard surface area, such as a rectangular area with a size of 2 m×2 m, or a circular area with a radius of 1 m. The reference states can be, for example: an optimal treatment status in which no sensor signal occurs per standard surface area, a normal treatment status in which up to ten sensor signals may occur per standard surface area, and a treatment status for a quick cleaning operation in which up to 50 sensor signals per standard surface area can occur. The user selects a desired target status from the defined reference status.

In addition, the user can transmit an indication of a type of contamination of the partial surface region 2 to be cleaned to the control device 5 of the floor treatment device 1. Since the detection device 9 may respond differently to different types of contamination, this facility allows the definition or selection of limits to be adjusted. The type of contamination can be sub-divided, for example, into coarse material, fine particles, hairs, fluids, sticky dirt and further categories. For a reliable determination of an actual treatment status, i.e. the level of contamination of the partial surface region 2, the user can also transmit information about a floor type to the control device 5 of the floor treatment device 1. The floor type can be defined, for example, in a previous cleaning run. If necessary, it may be useful to increase a reference contamination level, for example in the case of carpeted floors a factor relative to a hard floor, because it can be assumed that in a carpeted floor some fibres will be detected by the detection device 9 and interpreted as dirt.

The treatment of the partial surface region 2 can be started via a user interface on the floor treatment device 1 or else by means of the external terminal 15. During the treatment of the partial surface region 2 the detection device 9 measures a current treatment status, i.e. in this case a contamination status of the partial surface region 2, and if the contamination status at the end of a cleaning cycle is higher than the selected target cleaning status a new cleaning cycle is started, wherein this is advantageously performed along the previously selected trajectory 4. After the reference status, i.e. the reference contamination level, has been reached, a parked position of the floor treatment device 1 is advantageously activated. This can be, for example, a rest position on a base station of the floor treatment device 1.

The cleaning operations carried out by the user can be stored in a history and displayed to the user on the external terminal 15. For example, already cleaned partial surface regions 2 are advantageously displayed in an environment map 13 or an environment image 14, so that the user can make another selection quickly. For example, the user can select a plurality of partial surface regions 2, which are to be travelled to as successive partial surface regions 2 for a spot-cleaning operation. In addition, the user can choose whether the cleaning operation carried out and if required, its results, are entered into an environment map, 13 or an environment image 14, or whether these should be deleted without the possibility of subsequent use.

### LIST OF REFERENCE NUMERALS

1 floor treatment device
2 partial surface region
3 start/stop position
4 trajectory
5 control device
6 circumferential path
7 shape of area
8 size of area
9 detection device
10 wheel
11 cleaning element
12 distance measuring device
13 environment map
14 environment image
15 external terminal
16 display
17 treatment mode

What is claimed is:

1. A method for operating a floor treatment device that travels autonomously within an environment, comprising:
performing with the floor treatment device a treatment of a defined and spatially delimited partial surface region of the environment,
measuring during the treatment of the partial surface region a treatment status of the partial surface region with a detection device of the floor treatment device,
comparing the treatment status with a defined reference status,
continuing a treatment of the partial surface region until such time as the defined reference status is reached, wherein a user defines the reference status manually and transmits said status to the floor treatment device.

2. The method according to claim 1, wherein the treatment status is a contamination level of the partial surface region, wherein the contamination level is compared with a defined reference contamination level and wherein a cleaning of the partial surface region continues until the contamination level is below the defined reference contamination level.

3. The method according to claim 1, wherein in the defined spatially delimited partial surface region a spot cleaning mode with increased cleaning performance compared to a standard mode is implemented.

4. The method according to claim 1, wherein the reference status has a target specification for a treatment quality of the partial surface region.

5. The method according to claim 1, wherein the reference status is defined as a function of a type of the partial surface region and/or a type of contamination and/or a location and/or size of the partial surface region.

6. The method according to claim 1, wherein the treatment of the partial surface region comprises a plurality of temporally consecutive treatment cycles, wherein the step of comparing is performed during or after a treatment cycle.

7. The method according to claim 1, wherein the step of comparing is performed while the floor treatment device is stationary at a defined start/stop position.

8. The method according to claim 1, wherein during the treatment of the partial surface region the floor treatment device moves in a meandering trajectory or in trajectories oriented parallel to each other.

9. A floor treatment device which travels autonomously within an environment and is designed to perform a cleaning of a defined spatially delimited partial surface region of the environment, comprising a control device which is configured to control the floor treatment device and measure during the treatment of the partial surface region a treatment status of the partial surface region with a detection device of the floor treatment device, compare the treatment status with a defined reference status, and continue treatment of the partial surface region until such time as the defined reference status is reached, wherein a user defines the reference status manually and transmits said status to the floor treatment device.
